(19) United States
(12) Patent Application Publication
(10) Pub. No.: US 2024/0411539 A1
(43) Pub. Date: Dec. 12, 2024

(54) DYNAMIC AMELIORATION OF INDUSTRIAL ARTIFICIAL INTELLIGENCE ORCHESTRATOR SOFTWARE

(71) Applicant: International Business Machines Corporation, Armonk, NY (US)

(72) Inventors: Tushar Agrawal, West Fargo, ND (US); Jeremy R. Fox, Georgetown, TX (US); Sarbajit K. Rakshit, Kolkata (IN)

(21) Appl. No.: 18/330,665

(22) Filed: Jun. 7, 2023

(51) Int. Cl. G06F 8/65

(52) U.S. Cl. CPC G06F 8/65

(57) ABSTRACT

According to one embodiment, a method, computer system, and computer program product for managing artificial intelligence (AI) orchestration of machines and internet-of-things (IoT) devices of an industrial floor. The embodiment may include identifying a change in capability of at least one machine and/or IoT device of the industrial floor. The embodiment may include identifying executable functionality resulting from the identified change. The embodiment may include identifying one or more artificial intelligence (AI) software patches to perform the identified executable functionality. The embodiment may include installing the identified one or more AI software patches within the at least one machine and/or IoT device.

### BACKGROUND

The present invention relates generally to the field of computing, and more particularly to industrial artificial intelligence (AI) orchestration.

Industrial artificial intelligence (AI) refers to the use of AI technologies, such as machine learning (ML), computer vision, natural language processing, and robotics, in industrial applications and manufacturing processes. It involves the development and deployment of intelligent systems that can automate and optimize various industrial processes, including supply chain management and logistics, productivity improvement, cost reduction, site optimization, predictive analysis, and insight discovery. Industrial AI systems use data generated by sensors, machines, and other sources to analyze patterns and trends, make predictions, and generate insights that can help businesses make informed decisions and improve operational efficiency. For example, process manufacturers are increasingly integrating digital technologies, such as Internet-of-Things (IoT) devices, into their physical manufacturing processes to collect real-time data, and leveraging industrial AI solutions to monitor production lines, identify potential equipment failures, and optimize product quality, leading to increased productivity and reduced downtime.

### SUMMARY

According to one embodiment, a method, computer system, and computer program product for managing artificial intelligence (AI) orchestration of machines and internet-of-things (IoT) devices of an industrial floor. The embodiment may include identifying a change in capability of at least one machine and/or IoT device of the industrial floor. The embodiment may include identifying executable functionality resulting from the identified change. The embodiment may include identifying one or more artificial intelligence (AI) software patches to perform the identified executable functionality. The embodiment may include installing the identified one or more AI software patches within the at least one machine and/or IoT device.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for managing AI orchestration of machines and IoT devices of an industrial floor via an artificial intelligence orchestrator process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to industrial artificial intelligence (AI) orchestration. The following described exemplary embodiments provide a system, method, and program product to, among other things, evaluate changes in aggregated capability of an industrial floor to identify if governing AI orchestration software should be updated in accordance with the capabilities of the industrial floor. Therefore, the present embodiment has the capacity to improve the technical field of industrial artificial intelligence orchestration by dynamically updating AI orchestration software of an industrial floor to improve utilization of machines of the industrial floor and improve industrial floor productivity.

As previously described, industrial AI refers to the use of AI technologies, such as ML, computer vision, natural language processing, and robotics, in industrial applications and manufacturing processes. It involves the development and deployment of intelligent systems that can automate and optimize various industrial processes, including supply chain management and logistics, productivity improvement, cost reduction, site optimization, predictive analysis, and insight discovery. Industrial AI systems use data generated by sensors, machines, and other sources to analyze patterns and trends, make predictions, and generate insights that can help businesses make informed decisions and improve operational efficiency. For example, process manufacturers are increasingly integrating digital technologies, such as IoT devices, into their physical manufacturing processes to collect real-time data, and leveraging industrial AI solutions to monitor production lines, identify potential equipment issues, and optimize product quality, leading to increased productivity and reduced downtime.

In any industrial floor environment, there may be various machines and devices which may be computer controlled. These machines and devices may perform interactions with each other, and/or with human operators, to execute a given workflow. In such an environment. these interactions may be controlled by AI orchestration software which can receive various input data from existing machines and devices and identify an optimal set of respective functionalities which can be implemented within the workflow and managed by the AI software. However, as the machines and devices of the environment may have varying capabilities and perform varying activities, a change to equipment of the industrial floor (e.g., machine/device configuration changes and/or updates) may require one or more updates to the controlling AI orchestration software in order to utilize current capabilities of available equipment and optimize the workflow of the industrial floor. It may therefore be imperative to have an AI orchestration system in place to evaluate any change in aggregated capability of an industrial floor and, accordingly, identify if governing AI software of the industrial floor is to be updated to align with the evaluated aggregate capability. Thus, embodiments of the present invention may be advantageous to, among other things, identify newly installed, updated, or decommissioned input data gathering modules of machines of an industrial floor, identify installed sensors (e.g., IoT devices) of an industrial floor which require update or decommissioning, identify types of executable AI control/functionality resulting from change(s) to respective capabilities of existing industrial floor machines and/or sensors and, consequently, install appropriate/necessary AI orchestration software patches within respective machines and/or sensors, evaluate changes in aggregated capability/functionality of machines and sensors of an industrial floor, identify available or required updates to governing AI orchestration software based on changes in aggregated capability of an industrial floor and dynamically update the AI orchestration software, evaluate historical information collected from other industrial floors having a similar context and/or workflow, provide capacity/utilization recommendations and AI software recommendations for machines and sensors of an industrial floor based on evaluated historical information, and improve productivity and equipment utilization capacity of an industrial floor. The present invention does not require that all advantages need to be incorporated into every embodiment of the invention.

According to at least one embodiment, an AI orchestrator program may identify machines and IoT devices present within an industrial floor, as well as identify their respective properties and capabilities. Further, the AI orchestrator program may identify and control a contextual workflow executed via the machines and IoT devices. According to at least one embodiment, the AI orchestrator program may detect, or receive notification of, a change in capability of at least one machine and/or IoT device of the industrial floor. Based on the change in capability, the AI orchestrator program may identify a change in AI functionality which may be implemented within the industrial floor. In response to the identified change in AI functionality, the AI orchestrator program may install one or more AI software updates to govern the machines and IoT devices of the industrial floor so that their workflow aligns with the identified change in AI functionality. According to at least one other embodiment, the AI orchestrator program may provide utilization/capacity recommendations as well as capability upgrade recommendations for machines and/or IoT devices of the industrial floor based on industry best practices information and historical information collected from other industrial floors having a similar contextual workflow. According to at least one further embodiment, the AI orchestrator program may create and maintain a resource registry of machines and IoT devices of the industrial floor.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to evaluate any change in aggregated capability of equipment of an industrial floor and dynamically update governing AI orchestration software of the industrial floor to improve utilization of the equipment.

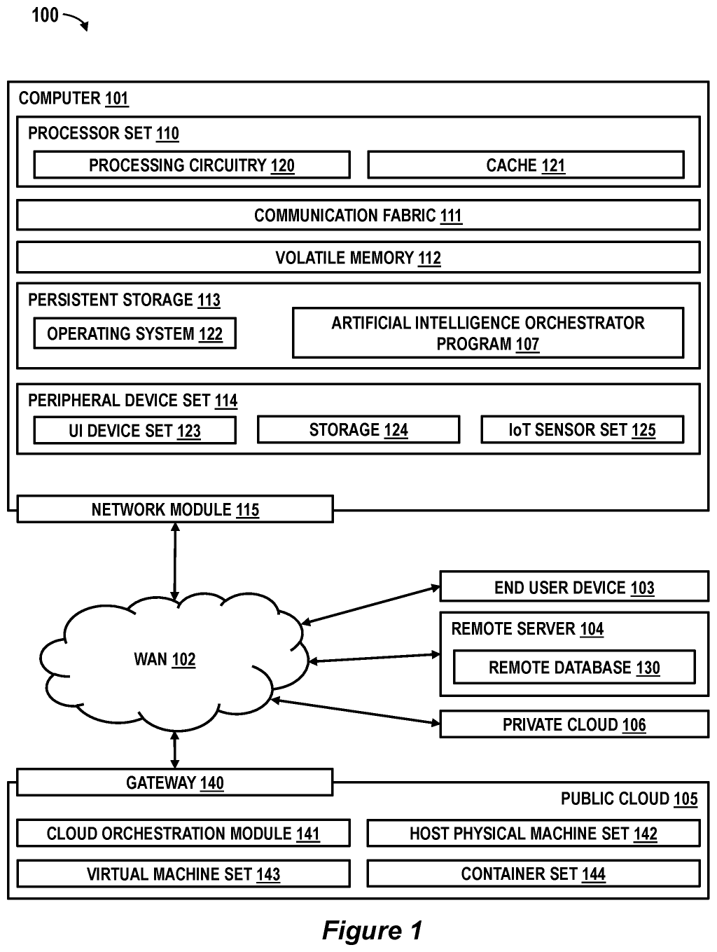

Referring to FIG. 1, an exemplary computing environment 100 is depicted, according to at least one embodiment. Computing environment 100 contains an example of an environment for the execution of at least some of the computer code involved in performing the inventive methods, such as artificial intelligence orchestrator (AIO) program 107. In addition to AIO program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AIO program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AIO program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in AIO program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be an IoT-enabled device (e.g., a sensor) or an IoT-enabled industrial machine capable of connecting to computer 101 via WAN 102 and network module 115 and capable of receiving instructions from AIO program 107. Although only a single EUD 103 is depicted, computing environment 100 may include a plurality of EUDs 103 (e.g., a plurality of IoT-enabled devices and IoT-enabled industrial machines).

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

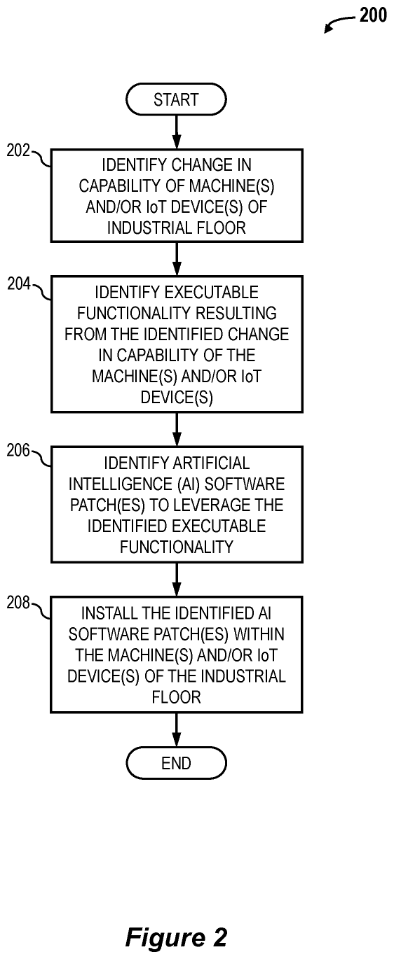

The AIO program 107 may be a program capable of identifying newly installed, updated, or decommissioned input data gathering modules of machines of an industrial floor, identifying installed IoT devices of an industrial floor which require update or decommissioning. receiving data from identified data gathering modules and IoT devices within an industrial floor, creating and maintaining a resource registry of machines and IoT devices of an industrial floor. identifying types of executable AI control/functionality resulting from change(s) to respective capabilities of existing industrial floor machines and/or IoT devices and, consequently, installing appropriate AI orchestration software patches within respective machines and/or IoT devices, evaluating changes in aggregated capability/functionality of machines and IoT devices of an industrial floor, identifying available or required updates to governing AI orchestration software based on changes in aggregated capability of an industrial floor and dynamically updating the AI orchestration software, evaluating historical information collected from other industrial floors having a similar context and/or workflow, providing capacity/utilization recommendations and AI software recommendations for machines and IoT devices of an industrial floor based on evaluated historical information, and improving productivity and equipment utilization capacity of an industrial floor. In at least one embodiment, AIO program 107 may require a user to opt-in to system usage upon opening or installation of AIO program 107. Notwithstanding depiction in computer 101, AIO program 107 may be stored in and/or executed by, individually or in any combination, end user device 103, remote server 104, public cloud 105, and private cloud 106 so that functionality may be separated among the devices. The artificial intelligence orchestrator method is explained in further detail below with respect to FIG. 2.

Referring now to FIG. 2, an operational flowchart for managing AI orchestration of machines and IoT devices of an industrial floor via an artificial intelligence orchestrator process 200 is depicted according to at least one embodiment. At 202, AIO program 107 identifies a change in operational capability of at least one machine and/or IoT device of an industrial floor. The industrial floor may include a plurality of machines (e.g., industrial machines) and IoT devices (e.g., IoT-enabled sensors) performing respective operations and functions and having respective attributes. These machines and IoT devices may interact with each other and/or with human operators to execute a contextual workflow (e.g., an industry specific task) of the industrial floor. According to at least one embodiment, AIO program 107 may communicate with the machines and IoT devices and manage their respective operations as well as their interactions with each other and/or human operators while performing the contextual workflow of the industrial floor. Identification, by AIO program 107, of a change in capability of a machine and/or IoT device may include identifying input data gathering module(s) of a machine which are newly installed, upgraded, or decommissioned, detecting the addition or removal of a machine or IoT device within the industrial floor, and identifying an IoT device which requires a hardware/software update or decommissioning. For example, AIO program 107 may identify a change in capability within an industrial floor as a result of detecting installation of an IoT-enabled smart lock which has been configured to communicate with AIO program 107 via WAN 102. According to at least one embodiment, AIO program 107 may periodically scan machines and IoT devices of the industrial floor to identify any changes in capability of the industrial floor from a previous state of capability. Further, AIO program 107 may receive input data of the industrial floor environment from IoT-enabled sensor devices (e.g., cameras, microphones, temperature sensors, decibel meters, moisture sensors, fire/smoke/hazardous gas sensors) within the industrial floor and in communication with AIO program 107. According to at least one further embodiment, AIO program 107 may receive, via WAN 102, notification of a change in operational capability from a machine and/or IoT device of the industrial floor.

According to at least one other embodiment, AIO program 107 may initially identify machines and IoT devices of the industrial floor during an initialization/set-up process of AIO program 107. Furthermore, AIO program 107 may create and maintain a resource registry which lists all identified machines and IoT devices of the industrial floor and documents their respective attributes. Attributes of a machine and/or IoT device may include one or more of an identifier, capabilities or functions, role(s)/activity performed, technical (e.g., hardware and software) specifications, maintenance requirements, input/output (I/O) requirements, network communication protocols, safety protocols, and best practices information. During the initialization/set-up process, AIO program 107 may extract the attribute information from the identified machines and IoT devices, or AIO program 107 may receive the attribute information from one or more system administrators (e.g., human operators). Additionally, the resource registry may also include software modules (e.g., software patches, a workplace risk analyzer model) utilized by the machines and IoT devices of the industrial floor in execution of the contextual workflow and a type identifier of the contextual workflow of the industrial floor. Based on the initial identification of the machines and IoT devices and evaluation of resource registry information, AIO program 107 may further identify a state of capability of the industrial floor which defines the currently executable operations that may be performed by machines and IoT devices of the industrial floor and their respective operation capacities. The resource registry and the state of capability of the industrial floor may be stored within storage 124 and/or remote database 130 and may be accessed (e.g., referenced, updated) by AIO program 107 when managing operation of the machines and/or IoT devices of the industrial floor in real-time.

Next, at 204, AIO program 107 identifies executable functionality (e.g., available operations/actions) resulting from the identified change in operational capability of the at least one machine and/or IoT device of the industrial floor. In identifying executable functionality, AIO program 107 may identify and recommend one or more types of AI-controlled actions (e.g., use cases) that can be executed with the machine and/or IoT device based on its identified change in operational capability. The AI-controlled actions may include actions or operations which may be performed by the machine and/or IoT device itself, or in collaboration with other machines and/or IoT devices, and which may be integrated within the execution of the contextual workflow of the industrial floor. As such, AIO program 107 may recommend what types of input data gathering modules or machine/IoT device capabilities are to be changed to leverage new or changed AI-controlled actions within the industrial floor. According to at least one embodiment, AIO program 107 may utilize an AI orchestration model, trained against known AI orchestration options implemented by AIO program 107 within industrial floors having a same contextual workflow type, to evaluate the resource registry (created during an initialization/set-up process of AIO program 107) of the industrial floor and recommend executable types of AI-controlled actions. As the AI orchestration model evaluates the resource registry of the industrial floor, AIO program 107 may, in response to identifying the change in operational capability of the at least one machine and/or IoT device, update the resource registry with information of the identified change before recommending executable types of AI-controlled actions. The AI orchestration model may be stored within storage 124 and/or remote database 130 and may be accessed by AIO program 107 when managing operation of the machines and/or IoT devices of the industrial floor in real-time.

Continuing with the smart lock example above, AIO program 107 may add the smart lock and its attribute information to an existing resource registry of the industrial floor in response to detecting its installation. For instance, the existing resource registry (which contains information of other machines and IoT devices of the industrial floor) may be updated with information of the smart lock including lock features, maintenance requirements, and I/O requirements. Among other lock features, AIO program 107 registers the following information: the smart lock can detect doors opening and shutting and can alert a pre-defined integration about this detection; the smart lock has a video camera that can stream video to other devices; the smart lock requires a battery change/re-charge when it reaches x % battery level; and the smart lock has an application programming interface (API). AIO program 107 may then evaluate the updated existing resource registry to identify and recommend one or more available types of AI-controlled actions based on features of the smart lock. For instance, AIO program 107 may recommend the following executable functionalities: AIO program 107 may shut off a machine of the industrial floor (e.g., a circle saw) when the smart lock alerts that a door of the industrial floor has been opened; AIO program 107 may execute a workplace risk analyzer model when the smart lock alerts that a door of the industrial floor has been opened and, based on input including a video stream from the smart lock and the existing resource registry of the industrial floor, AIO program 107 may analyze employee risk relative to their industrial floor protection wear; and AIO program 107 may detect a required smart lock battery change/charge and alert a human operator (e.g., a maintenance team member) via, for example, a pager integration resource.

At 206, AIO program 107 identifies one or more AI software patches to leverage the executable functionality identified at step 204. AIO program 107 may consider new or removed capabilities of the industrial floor and accordingly identify what types of AI-controlled use cases may be implemented within the contextual workflow of the industrial floor. According to at least one embodiment, in making this identification, AIO program 107 may access an AI software repository which maps types of AI-controlled actions (e.g., use cases) with respective enabling software modules. The AI software repository may include different AI modules (e.g., patches), executable by AIO program 107, to control different capabilities and functionalities based on industry best practices, the contextual workflow of the industrial floor, and available input data from machines and IoT devices. The AI software repository may be stored within storage 124 and/or remote database 130 and may be accessed (e.g., referenced, updated) by AIO program 107 when managing operation of the machines and/or IoT devices of the industrial floor in real-time. In furtherance of the smart lock example above, AIO program 107 may access the AI software repository and identify the required software modules to implement, within the industrial floor, one or more of the executable functionalities of the smart lock recommended at step 204. For instance, AIO program 107 may identify the software modules necessary to enable shutting off a machine of the industrial floor, such as the circle saw, when the smart lock alerts AIO program 107 that a door of the industrial floor has been opened. Accordingly, the identified necessary software modules may include a software patch for the smart lock and a software patch for the circle saw.

Next, at 208, AIO program 107 installs the identified one or more AI software patches within machine(s) and/or IoT device(s) of the industrial floor to leverage the identified change in operational capability of the at least one machine and/or IoT device. According to at least one embodiment, AIO program 107 may identify a time period for software module installations/updates (e.g., off peak hours, hours of low industrial floor activity, hours where utilization of machines and/or IoT devices of the industrial floor is at a minimum) and install or update identified software modules within respective machines and/or IoT devices of the industrial floor during the identified time period. In conclusion of the smart lock example above, AIO program 107 may install and/or update, within the smart lock and the circle saw, the respective software modules necessary to enable shutting off the circle saw of the industrial floor when the smart lock alerts AIO program 107 that a door of the industrial floor has been opened.

According to at least one other embodiment, installation of one or more identified software modules to leverage changed functionality within the contextual workflow of the industrial floor may include installing the identified one or more AI software modules within one or more machines and/or IoT devices of the industrial floor which were not previously managed by AIO program 107. In such an embodiment, AIO program 107 may enable AI orchestration of, and add “smart” features to, machines and/or IoT devices of an industrial floor which previously lacked such capability.

It may be appreciated that FIG. 2 provides only an illustration of one implementation and does not imply any limitations with regard to how different embodiments may be implemented. Many modifications to the depicted environments may be made based on design and implementation requirements.

According to at least one further embodiment, AIO program 107 may evaluate change(s) in an aggregated capability (e.g., a capability of the machines and/or IoT devices as a whole) of an industrial floor and identify if AI software implemented within the industrial floor should be updated in accordance with the capabilities available on the floor to improve utilization of equipment (i.e., machines and IoT devices) capacity and improve contextual workflow productivity of the industrial floor. Additionally, AIO program 107 may dynamically update the implemented AI software to align with the identified/evaluated aggregate capabilities of the industrial floor so that the industrial floor may utilize the full capacity of the machines and/or IoT devices contained therein.

According to yet another embodiment, AIO program 107 may analyze the existing capabilities of an industrial floor as well as analyze historically captured information and best practice information from various other industrial floors having a same or similar contextual workflow type, and, accordingly, AIO program 107 may recommend types of upgrades in the capabilities of machines and/or IoT devices of the industrial floor to improve equipment utilization and productivity. Historically captured information and best practice information from various other industrial floors may be stored within storage 124 and/or remote database 130 and may be accessed (e.g., referenced, updated) by AIO program 107 when managing operation of the machines and/or IoT devices of the industrial floor in real-time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
identifying a change in capability of at least one machine and/or internet-of-things (IoT) device of an industrial floor;
identifying executable functionality resulting from the identified change;
identifying one or more artificial intelligence (AI) software patches to perform the identified executable functionality; and
installing the identified one or more AI software patches within the at least one machine and/or IoT device.

2. The method of claim 1, wherein the industrial floor comprises a plurality of machines and IoT devices performing respective operations and functions and having respective attributes, and wherein the machines and IoT devices interact with each other and/or with human operators to execute a contextual workflow of the industrial floor, and wherein operation of the machines and IoT devices in the execution of the contextual workflow is managed by AI software.

3. The method of claim 1, wherein identifying the change in capability comprises at least one of identifying at least one input data gathering module of the at least one machine which is newly installed, upgraded, or decommissioned, detecting the addition or removal of the at least one machine and/or IoT device within the industrial floor, and identifying that the at least one IoT device requires a software update or decommissioning.

4. The method of claim 2, wherein the executable functionality comprises one or more types of AI-controlled actions that can be executed with the at least one machine and/or IoT device based on its identified change in capability, and wherein the one or more types of AI-controlled actions comprise actions or operations which are performed by the at least one machine and/or IoT device itself, or in collaboration with other machines and/or IoT devices of the industrial floor, and which are integrated within execution of the contextual workflow of the industrial floor.

5. The method of claim 2, further comprising:
evaluating a change in an aggregated capability of the industrial floor; and
updating the AI software to align with the evaluated aggregated capability so that the industrial floor utilizes a full capacity of the machines and/or IoT devices.

6. The method of claim 1, further comprising:
analyzing existing capabilities of the industrial floor;
analyzing historically captured information and best practice information from various other industrial floors having a same contextual workflow as the industrial floor; and
recommending types of upgrades in the capabilities of machines and/or IoT devices of the industrial floor.

7. The method of claim 1, wherein the identifying executable functionality utilizes an AI orchestration model, trained against known AI orchestration options implemented within other industrial floors having a same contextual workflow as the industrial floor, to evaluate a resource registry of the industrial floor and recommend executable types of AI-controlled actions.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a change in capability of at least one machine and/or internet-of-things (IoT) device of an industrial floor;
identifying executable functionality resulting from the identified change;
identifying one or more artificial intelligence (AI) software patches to perform the identified executable functionality; and
installing the identified one or more AI software patches within the at least one machine and/or IoT device.

9. The computer system of claim 8, wherein the industrial floor comprises a plurality of machines and IoT devices performing respective operations and functions and having respective attributes, and wherein the machines and IoT devices interact with each other and/or with human operators to execute a contextual workflow of the industrial floor, and wherein operation of the machines and IoT devices in the execution of the contextual workflow is managed by AI software.

10. The computer system of claim 8, wherein identifying the change in capability comprises at least one of identifying at least one input data gathering module of the at least one machine which is newly installed, upgraded, or decommissioned, detecting the addition or removal of the at least one machine and/or IoT device within the industrial floor, and identifying that the at least one IoT device requires a software update or decommissioning.

11. The computer system of claim 9, wherein the executable functionality comprises one or more types of AI-controlled actions that can be executed with the at least one machine and/or IoT device based on its identified change in capability, and wherein the one or more types of AI-controlled actions comprise actions or operations which are performed by the at least one machine and/or IoT device itself, or in collaboration with other machines and/or IoT devices of the industrial floor, and which are integrated within execution of the contextual workflow of the industrial floor.

12. The computer system of claim 9, the method further comprising:
evaluating a change in an aggregated capability of the industrial floor; and
updating the AI software to align with the evaluated aggregated capability so that the industrial floor utilizes a full capacity of the machines and/or IoT devices.

13. The computer system of claim 8, the method further comprising:
analyzing existing capabilities of the industrial floor;
analyzing historically captured information and best practice information from various other industrial floors having a same contextual workflow as the industrial floor; and
recommending types of upgrades in the capabilities of machines and/or IoT devices of the industrial floor.

14. The computer system of claim 8, wherein the identifying executable functionality utilizes an AI orchestration model, trained against known AI orchestration options implemented within other industrial floors having a same contextual workflow as the industrial floor, to evaluate a resource registry of the industrial floor and recommend executable types of AI-controlled actions.

15. A computer program product, the computer program product comprising:
one or more computer-readable tangible storage medium and program instructions stored on at least one of the one or more tangible storage medium, the program instructions executable by a processor capable of performing a method, the method comprising:
identifying a change in capability of at least one machine and/or internet-of-things (IoT) device of an industrial floor;
identifying executable functionality resulting from the identified change;
identifying one or more artificial intelligence (AI) software patches to perform the identified executable functionality; and
installing the identified one or more AI software patches within the at least one machine and/or IoT device.

16. The computer program product of claim 15, wherein the industrial floor comprises a plurality of machines and IoT devices performing respective operations and functions and having respective attributes, and wherein the machines and IoT devices interact with each other and/or with human operators to execute a contextual workflow of the industrial floor, and wherein operation of the machines and IoT devices in the execution of the contextual workflow is managed by AI software.

17. The computer program product of claim 15, wherein identifying the change in capability comprises at least one of identifying at least one input data gathering module of the at least one machine which is newly installed, upgraded, or decommissioned, detecting the addition or removal of the at least one machine and/or IoT device within the industrial floor, and identifying that the at least one IoT device requires a software update or decommissioning.

18. The computer program product of claim 16, wherein the executable functionality comprises one or more types of AI-controlled actions that can be executed with the at least one machine and/or IoT device based on its identified change in capability, and wherein the one or more types of AI-controlled actions comprise actions or operations which are performed by the at least one machine and/or IoT device itself, or in collaboration with other machines and/or IoT devices of the industrial floor, and which are integrated within execution of the contextual workflow of the industrial floor.

19. The computer program product of claim 16, the method further comprising:
evaluating a change in an aggregated capability of the industrial floor; and
updating the AI software to align with the evaluated aggregated capability so that the industrial floor utilizes a full capacity of the machines and/or IoT devices.

20. The computer program product of claim 15, the method further comprising:
analyzing existing capabilities of the industrial floor;
analyzing historically captured information and best practice information from various other industrial floors having a same contextual workflow as the industrial floor; and
recommending types of upgrades in the capabilities of machines and/or IoT devices of the industrial floor.
